(19) United States
(12) Patent Application Publication
(10) Pub. No.: US 2002/0187911 A1
(43) Pub. Date: Dec. 12, 2002

(54) Viscosity and softening enhancement by low-solids rinse cycle fabric softeners based on quaternary ammonium compounds and amine ethoxylates

(75) Inventor: Jen Farn Liew, Singapore (SG)

Correspondence Address: Leopold Presser, Esq., Scully, Scott, Murphy & Presser, 400 Garden City Plaza, Garden City, NY, 11530, US

(73) Assignee: GOLDSCHMIST CHEMICAL COMPANY, HOPEWELL, VA (US)

(21) Appl. No.: 09/799,454

(22) Filed: Mar. 5, 2001

(51) Int. Cl. C11D 3/00; D06L 1/00

(52) U.S. Cl. 510/327; 510/329; 510/330; 510/515

(57) ABSTRACT

A high-viscosity, low-solids fabric softener formulation comprising (a) a low-solids fabric softener composition which includes from about 1 to about 10% of at least one dialkyl quaternary ammonium compound dispersed in water; and (b) at least one amine ethoxylate having the formula(R(nEO))ₛNHₜ, wherein R is a saturated or unsaturated, linear or branched alkyl containing from 10 to 22, preferably 12-18, carbon atoms; EO is ethoxylate; n is the number of moles of EO and is from 1 to 10, preferably 2-5; s=1, 2 or 3; t=0, 1 or 2, and s+t=3. The addition of the amine ethoxylate to the low-solids fabric softener composition enhances not only the viscosity of the fabric softener composition, but also the softening performance thereof. The enhanced viscosity is achieved without the use of any polymeric thickening agents.

### FIELD OF THE INVENTION

The present invention relates to fabric softeners, and more particularly to a low-solids rinse cycle fabric softener having enhanced viscosity and softening associated therewith. Specifically, the present invention relates to a low-solids rinse cycle fabric softener formulation that includes at least one dialkyl quaternary ammonium compound and at least one amine ethoxylate, wherein the at least one amine ethoxylate enhances the viscosity and softening capability of the dialkyl quaternary ammonium compound.

### BACKGROUND OF THE INVENTION

In the field of laundering, it is well known to add a liquid fabric softener containing at least one softening agent such as a cationic quaternary ammonium compound or salt thereof directly into the laundering process. The addition of the liquid fabric softener typically occurs during the rinse cycle itself.

Rinse cycle fabric softeners are provided in two forms: concentrated (i.e., high-solids) compositions containing more than 10% by weight of fabric softener agents, and diluted (i.e., low-solids) compositions containing less than 10% by weight of fabric softener agents. Consumer acceptance of rinse cycle fabric softeners is determined not only by the performance achieved with these products, but also by the aesthetics associated therewith. For example, high-viscosity fabric softeners (having a viscosity on the order of 500 cps or higher) are perceived by some consumers to be superior to low-viscosity fabric softeners. Viscosity of the rinse cycle fabric softener is therefore an important aspect of the successful formulation of such commercial products.

In attempts to increase the viscosity of low-solids fabric softeners, it is known to add polymeric thickening agents such as polyacrylamides, polysaccharides and polyurethanes to the fabric softener formulation. Large quantities of thickening agents are typically required in order to provide effective thickening of low-viscosity fabric softeners. While the use of such high quantities of thickening agents would provide a solution to the viscosity problem, this solution leads to increased cost in formulating the fabric softener which cost is passed along to the consumer.

This increased formulation cost is further compounded in that conventional polymeric thickening agents typically provide no additional benefits to the fabric softener formulation. Thus, additional ingredients besides thickening agents which further enhance the formulation performance are typically required.

In view of the drawbacks of the prior art mentioned above, it would be beneficial to provide a new and cost effective means for improving the viscosity of low-solids rinse cycle fabric softeners which does not require the use of conventional polymeric thickeners.

### SUMMARY OF THE INVENTION

The present invention relates to high-viscosity, low-solids fabric softener formulations in which viscosity and softening enhancement of low-viscosity, low-solids fabric softeners is achieved by adding at least one amine ethoxylate having less than 10 moles of ethoxylate (EO) present therein to the fabric softener. The use of the amine ethoylate having the above content of EO unexpectedly increases the viscosity and the softening performance of the low-solids fabric softener.

The term “high-viscosity” fabric softener is used herein to denote a fabric softener having a viscosity on the order of about 500 cps or above, whereas the term “low-viscosity” fabric softener denotes a fabric softener composition having a viscosity of below, about 500 cps.

The term “high-solids” denotes a fabric softener composition in which the fabric softener component, i.e., quaternary ammonium compound, is present in an amount of greater than 10% by weight, whereas the term “low-solids” denotes a fabric softener composition in which the fabric softener component is present in an amount of about 10% by weight or less, preferably, about 1 to about 10% by weight, and even more preferably, about 2 to about 5% by weight. 10.

Specifically, the present invention provides a high-viscosity, low-solids fabric softener formulation which comprises:

(a) a low-solids fabric softener composition which includes from about 1 to about 10% by weight of at least one dialkyl quaternary ammonium compound dispersed in water; and

(b) at least one amine ethoxylate having the formula (R(nEO))ₛNHₜ, wherein R is a saturated or unsaturated, linear or branched alkyl containing from 10 to 22, preferably 12-18, carbon atoms; EO is ethoxylate; n is the number of moles of EO and is from 1 to 10, preferably 2-5; s=1, 2 or 3; t=0, 1 or 2; and s+t=3.

The addition of the amine ethoxylate to the low-solids fabric softener composition enhances not only the viscosity of the fabric softener composition, but also the softening performance thereof. The enhanced viscosity is achieved in the present invention without the use of any polymeric thickening agents.

The high-viscosity, low-solids rinse cycle fabric softener formulation of the present invention is used in the rinse cycle of any laundering process wherein conventional detergents are employed. The rinse cycle fabric softener formulation of the present invention is used in an amount of from about 0.05 to about 0.4 weight % of said fabric softener formulation, per 100 grams of fabric to be laundered.

In accordance with another aspect of the present invention, a method of increasing the viscosity and softening of a low-solids fabric softener composition is provided. Specifically, the inventive method comprises the steps of:

(a) providing a low-solids fabric softener composition which includes from about 1 to about 10% by weight of at least one dialkyl quaternary ammonium compound dispersed in water; and

(b) adding at least one amine ethoxylate having the formula(R(nEO))ₛNHₜ, wherein R is a saturated or unsaturated, linear or branched alkyl containing from 10 to 22, preferably 12-18, carbon atoms; EO is ethoxylate; n is the number of moles of EO and is from 1 to 10, preferably 2-5; s=1, 2 or 3; t=0, 1 or 2; and s+t=3, to said low-solids fabric softener composition, wherein said amine ethoxylate enhances the viscosity and softening of said low-solids fabric softener composition

### DETAILED DESCRIPTION OF THE INVENTION

As stated above, the present invention relates to a high-viscosity, low-solids rinse cycle fabric softener formulation which includes at least a low-solids fabric softener composition containing a dialkyl quaternary ammonium compound dispersed in water.

Suitable dialkyl quaternary ammonium compounds (hereinafter referred to “dialkyl quats”) that can be employed in the present invention include: dialkyl ester quats, dialkyl amido amine quats, dialkyl imidazoline quats and combinations and mixtures thereof.

The terms “ester-containing quaternary ammonium” or “ester quats” are used herein to denote a quaternary ammonium compound having the following formula:

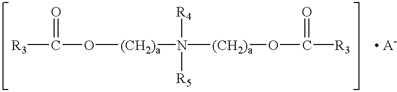

wherein each R₃ is the same or different and is a saturated C₉₋₂₃, preferably C₁₅₋₁₇, alkyl; R₄ and R₅ are the same or different and are C₁₋₆ hydrocarbyl group or hydroxy alkyl; and a is from 1 to 6, preferably 2 to 3. The term “hydrocarbyl” is used herein to denote aliphatic (i.e., a linear or branched, saturated hydrocarbon group, that is, alkyl groups), cycloaliphatic, aryl, alkaryl and aralkyl groups. In the above formulas, A is an anion selected from the group of chloride, bromide, methyl sulfate, ethyl sulfate, formate, actetate, carbonate, sulfate, nitrate and other like anions. Preferred anions are chloride and methyl sulfate.

Examples of ester-containing quats that can be employed in the present invention include, but are not limited to: REWOQUAT WE-HV (i.e., di-(hydrogenated nortallow carboxyethyl) hydroxyethyl methylammonium methosulfate)and VARISOFT WE-16 (i.e., di-(nortallow carboxyethyl) hydroxyethyl methylammonium methosulfate) supplied by Goldschmidt Chemical Corporation.

The term “amido amine quaternary ammonium compound” is used herein to denote a quaternary ammonium compound having the following formula:

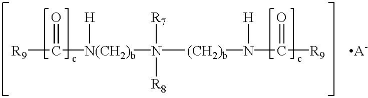

wherein R₇ and R₈ are the same or different and are C₁₋₄ alkyls, ethoxy or propoxy; each R₉ is the same or different and is a saturated C₇₋₂₇ alkyl; c is 0 or 1; b is 1 to 6; and A is an anion selected from the group mentioned above. Examples of amido amine quats that can be employed in the present invention include, but are not limited to: VARISOFT 110-75% (i.e., methyl bis-(hydrogenated tallow amidoethyl) 2-hydroxyethyl ammonium methosulfare) or VARISOFT 222 LM-90 (i.e., N, N-bis-(tallow amidoethyl) N-polyethoxy N-methylammonium methosulfate).

The term “imidazoline quat” is used herein to. denote a quaternary ammonium compound having the following formula:

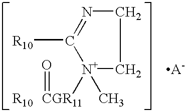

wherein R₁₀ is a saturated C₁₁₋₂₁ alkyl; R₁₁ is a divalent C₁₋₆ alkyl group; G is O or NH; and A is one of the above-mentioned anions. Examples of imidazoline quats that can be employed in the present invention include, but are not limited to: REWOQUAT W75H (i.e., 1-methyl-2-norhydrogenated tallow-3-hydrogenated tallow amidoethyl imidazolinium methosulfate), VARISOFT 445 (i.e., methyl-1-hydrogenaated tallow imidazolinium methylsulfate) or VARISOFT 475 (i.e., 1-methyl-2-nortallowakyl-3-tallow amidecethyl imodazolinium methosulfate).

Of the various dialkyl quaternary ammonium fabric softeners mentioned above, it is preferred to utilize a dialkyl imidazoline such as REWOQUAT W75H as the cationic fabric softener agent.

Notwithstanding which of the dialkyl quats is employed in the present invention, the low-solids fabric softener composition of the present invention comprises from about 1 to about 10% by weight, more preferably from about 2 to about 5% by weight, of at least one dialkyl quat dispersed in water.

The low-solids fabric softener composition employed in the present invention may comprise any number of well known fabric softener components such as brighteners that are typical present in such compositions. Moreover, the low-solids fabric softener composition is made utilizing standard procedures that are also well known to those skilled in the art. For example, the low-solids fabric softener composition can be made by dispersing the dialkyl quat component in water at room or elevated temperatures in the presence of a mechanical stirrer.

The low-solids fabric softener compositions which are employed in the present invention are further characterized as having a viscosity on the order of about 500 cps or less, with a viscosity range of from about 100 to about 300 cps being more preferred. As stated above, such low-viscosity composition are perceived by some consumers as being inferior to high-viscosity fabric softeners.

To increase the viscosity of the low-solids fabric softener compositions to desirable aesthetic levels, at least one amine ethoxylate having the formula (R(nEO))ₛNHₜ is added to the low-solids fabric softener composition. In the above formula, R is a saturated or unsaturated, linear or branched alkyl containing from 10 to 22, preferably 12-18, carbon atoms; EO is ethoxylate; n is the number of moles of EO and is from 1 to 10, preferably 2-5; s=1, 2 or 3; t=0, 1 or 2; and s+t=3.

Of the various amine ethoxylates that can be employed in the present invention, it is preferred to employ VARONIC T202 which is an ethoxylated tallow amine supplied by Sherex Co.

Notwithstanding which amine ethoxylate is employed in the present compositions, the enhanced viscosity of the low-solids fabric softener composition is obtained by adding from about 0.1 to about 1.5% by weight of amine ethoxylate to the low-solids fabric softener composition. More preferably, enhanced viscosity is achieved in the present invention when from about 0.5 to about 1.0% by weight of amine ethoxylate is added to the low-solids fabric softener composition.

The addition of the amine ethoxylate to the low-solids fabric softener compositions is carried out by conventional means well known to those skilled in the art. For example, the addition may be carried out by the incremental addition of small quantities of amine ethoxylate into the low-solids fabric softener composition with continuous stirring, or alternatively, the amine ethoxylate can be added all at once to the low-solids fabric softener composition.

The use of amine ethoxylates in fabric softener compositions is well known in the art. However, when the prior art employs the amine ethoxylate, the EO content is typically 15 moles or higher. In such prior art applications, the amine ethoxylate serves to aid in the dispersibility of the quat component. The inventor is not aware of any prior art that discloses the use of the above-defined amine ethoxylate having an EO content of 10 moles or less which functions to enhance the viscosity of a low-solids fabric softener composition.

In addition to the unexpected viscosity enhancement, the inventor has also unexceptedly determined that the use of the above described amine ethoxylate (EO 10 moles or less) provides enhanced softening which is not observed using an amine ethoxylate having an EO content of 15 moles or more.

Thus, the present invention not only provides enhanced viscosity to low-solids fabric softener compositions, but also provides improved softening properties thereto. This synergistic enhancement has not been reported for fabric softeners containing amine ethoxylates.

The high-viscosity, low-solids rinse cycle fabric softener formulation of the present invention can be added during the rinse cycle of a laundering process wherein any detergent is present in the laundry liquor. That is, the inventive high-viscosity, low-solids rinse cycle fabric softener formulation can be added to a laundering liquor that contains anionic surfactants, non-ionic surfactants, amphoteric surfactants, zwitterionic surfactants or any combinations or mixtures thereof.

Suitable anionic surfactants that can be employed in the detergent composition include water soluble salts, preferably the alklai metal, ammonium and alkylammonium salts of organic sulfuric acid reaction products having in their molecular structure an alkyl group containing from about 10 to about 20 carbon atoms and a sulfonic acid or sulfuric acid ester group. (Included in the term “alkyl” is the alkyl portions of acyl groups).

Some illustrative examples of the above type of anionic surfactants are the sodium and potassium alkyl sulfates, especially those obtained by sulfating higher C₈₋₁₈ alcohols, such as those produced by reducing the glycerides of tallow or coconut oil; and the sodium and potassium alkylbenzene sulfonates in which the alkyl group is straight chained or branched, and the alkyl contains from about 9 to about 15 carbon atoms. The alkylbenzene sulfonates of the former type are described, for example, in U.S. Pat. Nos. 2,220,099 and 2,477,383, the contents or each reference is incorporated herein by reference.

Especially preferred alkylbenzene sulfonates are linear straight chain alkylbenzene sulfonates in which the average number of carbon atoms in the alkyl group is from about 10 to 15, abbreviated as C₁₀₋₁₅ LAS. The alkali salts, particularly the sodium salts of these anionic surfactants are preferred. Alkylbenzene sulfonates and ,processes for producing the same are disclosed, for example, in U.S. Pat. Nos. 2,220,099 and 2,477,383.

Other anionic surfactants that can be employed in the detergent composition include alkyl alkoxylated sulfates. These compounds are water-soluble salts or acids having the formula R₁₅O(E)ₘSO₃M wherein R₁₅ is an unsubstituted C₁₀₋₂₄ alkyl or hydroxyalkyl group having a C₁₀₋₁₈ alkyl or hydroxyalkyl group; E is an ethoxy or propoxy unit; m is greater than zero, preferably m is between about 0.5 and about 6; and M is hydrogen or a water soluble cation which can be, for example, a metal cation (e.g., sodium, potassium, lithium, calcium, magnesium, etc.), ammonium or substituted-ammonium cation. Specific examples of substituted ammonium cations include, but are not limited to: methyl-, ethyl-, dimethyl-, trimethyl-ammonium and quaternary ammonium cations, such as tetramethyl-ammonium, dimethyl piperdinum and cations derived from alkanolamines such as monoethanolamine, diethanolamine and triethlamine, and mixtures thereof.

Illustrative examples of the foregoing alkyl alkoxylated sulfates include: C₁₂₋₁₈ alkyl polyethoxylate (1.0) sulfate, C₁₂₋₁₈ alkyl polyethoxylate (2.25) sulfate, C₁₂₋₁₈ alkyl polyethoxylate (3.0) sulfate, C₁₂₋₁₈ alkyl polyethoxylate (4.0) sulfate, wherein M is sodium or potassium.

Other anionic surfactants useful in the detergent compositions include sodium alkyl glyceryl ether sulfonates, particularly those ethers of higher alcohols derived from tallow and coconut oil; sodium coconut oil fatty acid monoalyceride sulfonates and sulfates.

Still further anionic surfactants include water-soluble salts of esters of alpha-sulfonated fatty acids containing from about 6 to about 20 carbon atoms in the fatty acid portion of the compound and from 1 to about 10 carbon atoms in the ester group; water-soluble salts of 2-acyloxyalkane-1-sulfonic acids containing from about 2 to about 9 carbon atoms in the acyl portion of the compound and from about 9 to about 23 carbon atoms in the alkane moiety; water-soluble salts of olefin and paraffin sulfonates containing from about 12 to about 20 carbon atoms; and beta-alkyloxy alkane sulfonates containing from 1 to about 3 carbon atoms in the alkyl group and from about 8 to about 20 carbon atoms in the alkane moiety.

Typical nonionic surfactants that can be present in the detergent composition include polyethylene, polypropylene and polybutylene oxide condensates of alkyl phenols. Other examples or nonionic surfactants include: condensation products of primary and secondary aliphatic alcohols, alkylpolysaccharides, condensation products of ethylene oxide with a hydrophobic base formed by the condensation of propylene oxide with propylene glycol, condensation products of ethylene oxide with the product resulting from the reaction of propylene oxide and ethylenediamine, and polyhydroxy fatty acid amides.

The detergent may also include any conventional amphoteric or zwitterionic surfactant therein. The use of the inventive high-viscosity, low-solids rinse cycle fabric softener formulation is not limited to a specific type of detergent, but rather the rinse cycle fabric softener formulation of the present invention can be used with any conventional detergent.

In addition to the above ingredients, the detergent composition may also include conventional detergent builders, enzymes, bleaching agents, bleach activators, polymeric soil release agents, chelating agents, soil release and anti-redeposition agents, dispersing agents, optical brighteners, whitening agents, betaines, sultanies and other like components that may be typically used in laundry detergents. Since all these compounds are conventional, a detailed description of the optional components is not provided herein. A detailed description of these detergent components however can be found, for example, in WO 98/53034, the contents of which is incorporated herein by reference.

Operational Use:

The high-viscosity, low-solids rinse cycle fabric softener formulation of the present invention is typically added to the rinse cycle of a laundry process utilizing conventional washing temperatures of about 20° C. to about 60° C. and rinsing temperatures of about 10° C. to about 50° C. The rinse cycle fabric softener formulation of the present invention is effective over a wide range of water hardness levels.

The rinse cycle fabric softener formulation of the present invention may be used in laundering operations by adding the formulation to a laundering vessel in amounts that are typically used. Specifically, the inventive rinse cycle formulation of the present invention is used in an amount of from about 20 g to about 120 g solids content of fabric softener with a 3 to 8 pound load of clothing to be washed. The particular amount of fabric softener used in the rinsing cycle is not however critical to the present invention.

The following examples are given to illustrate the present invention and to demonstrate some advantages that can be obtained from utilizing the same.

### EXAMPLE

The softening performance of imidazoline quats blended with VARONIC T202 (i.e., tallow amine+2 EO) was evaluated and compared against that of imicazoline quats alone and ADCGEN 442 (i.e., hydrogenated tallow dimethyl ammonium chloride)

Test Parameters

The following softeners were evaluated:

S1=REWOQUAT W75 (i.e., a tallow imidazolinium)/VARONIC T202 (95:5); comparative example.

S2=REWOQUAT W75H/VARONIC T202 (95:5); representative of the present invention.

S3=ADOGEN 442; comparative example.

S4=REWOQUAT W75; comparative example.

S5=REWOQUAT W75H; comparative example.

The conditions used for this evaluation were as follows:

Water Temperature=25° C.

Water Type=Tap water

Water Volume=1.5L

Fabric Weight=2×38 g

Softener Dosage=0.2% based on dry fabric weight

Fabric Type: Terry cloth face towels

Drying Method=Air dried overnight

Softening Duration=3 minutes

Softening Evaluation

The towels were divided into two sets of five. A panel of six was selected to rank each set of towels from best (5) to worst (1). Two trials were conducted, and the sums were added together to determine the overall performance of the sample.

Results

REWOQUAT W75H and REWOQUAT W75H/VARONIC T202 both gave better softening than ADOGEN 442, but REWOQUAT W75 and REWOQUAT W75H/VARONIC T202 gave only adequate softening. See Table 1. Thus under the above conditions, REWOQUAT W75H achieved better softening than ADOGEN 442. REWOQUAT W75 expectedly softened less compared to the rest because it was made from soft tallow. VARONIC T202 had no adverse effect on the softening performance of imidazoline quats at all. Instead, it enhanced the softening and improved the viscosity of low-solids fabric softeners.

TABLE 1
Softening results

| Panelist | S3 | S5 | S2 | S4 | S1 |
|---|---|---|---|---|---|
| A | 3 | 5 | 4 | 1 | 2 |
| | 4 | 5 | 2 | 3 | 1 |
| B | 2 | 4 | 5 | 1 | 3 |
| | 3 | 4 | 5 | 2 | 1 |
| C | 3 | 4 | 5 | 1 | 2 |
| | 4 | 3 | 2 | 5 | 1 |
| D | 2 | 3 | 5 | 1 | 4 |
| | 3 | 4 | 5 | 1 | 2 |
| E | 2 | 3 | 4 | 1 | 5 |
| | 2 | 3 | 5 | 4 | 1 |
| F | 4 | 3 | 5 | 1 | 2 |
| | 3 | 4 | 5 | 2 | 1 |
| Total | 35 | 45 | 52 | 23 | 25 |
| Score | | | | | |

While the present invention has been particularly shown and described with respect to preferred embodiments thereof, it will be understood by those skilled in the art that the foregoing and other changes in form and detail may be made without departing from the spirit and scope of the present invention. It is therefore intended that the present invention not be limited to the exact forms described and illustrated, but fall within the scope of the appended claims.

What is claimed is:

1. A high-viscosity, low-solids fabric softener formulation comprising:
(a) a low-solids fabric softener composition comprising from about 1 to about 10% of at least one dialkyl quaternary ammonium compound dispersed in water;. and
(b) at least one amine ethoxylate having the formula (R(nEO))ₛNHₜ, wherein R is a saturated or unsaturated, linear or branched alkyl containing from 10 to 22 carbon atoms; EO is ethoxylate; n is the number of moles of EO and is from 1 to 10; s=1, 2 or 3; t=0, 1 or 2; and s+t=3, with the proviso that no polymeric thickening agent is present.

2. The high-viscosity, low-solids fabric softener formulation of claim 1 wherein said at least one dialkyl quaternary ammonium compound is a dialkyl ester quat, a dialkyl amido amine quat, a dialkyl imidazoline quat or combinations and mixtures thereof.

3. The high-viscosity, low-solids fabric softener formulation of claim 2 wherein said dialkyl quaternary ammonium compound is a dialkyl ester quat having the formula: 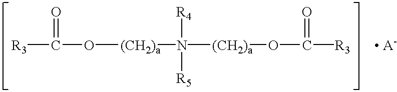
wherein each R₃ is the same or different and is a saturated C₉₋₂₃ alkyl; R₄ and R₅ are the same or different and are C₁₋₆ hydrocarbyl group or hydroxy alkyl; a is from 1 to 6; and A is an anion selected from the group consisting of chloride, bromide, methyl sulfate, ethylsulfate, formate, acetate, carbonate, sulfate, and nitrate.

4. The high-viscosity, low-solids fabric softener formulation of claim 3 wherein said diakyl ester quat is REWOQUAT WE-HV or VARISOFT WE-16.

5. The high-viscosity, low-solids fabric softener formulation of claim 2 wherein said dialkyl quaternary ammonium compound is a dialkyl amido amine quat having the following formula: 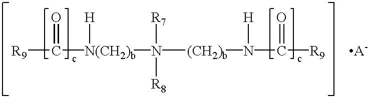
wherein R₇ and R₈ are the same or different and are C₁₋₄ alkyls, ethoxy or propoxy; each R₉ is the same or different and is a saturated C₇₋₂₇ alkyl; c is 0 or 1; b is 1 to 6; and A is an anion selected from the group consisting of chloride, bromide, methyl sulfate, ethylsulfate, formate, acetate, carbonate, sulfate, and nitrate.

6. The high-viscosity, low-solids fabric softener formulation of claim 5 wherein said dialkyl amido amine quat is VARISOFT 110-75%.

7. The high-viscosity, low-solids fabric softener of claim 2 wherein said dialkyl ammonium quaternary ammonium compound is a dialkyl imidazoline quat having the following formula: 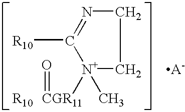
wherein R₁₀ is a saturated C₁₁₋₂₁ alkyl; R₁₁ is a divalent C₁₋₆ alkyl group; G is O or NH; and A is an anion selected from the group consisting of chloride, bromide, methyl sulfate, ethylsulfate, formate, acetate, carbonate, sulfate, and nitrate.

8. The high-viscosity, low-solids fabric softener formulation of claim 7 wherein the dialkyl imidazoline quat is REWOQUAT W75H.

9. The high-viscosity, low-solids fabric softener formulation of claim 1 wherein said low-solids fabric softener composition comprises from about 2 to about 5% of said at least one dialkyl quaternary ammonium compound dispersed in water.

10. The high-viscosity, low-solids fabric softener formulation of claim 1 wherein said amine ethoxylate contains from about 12-18 carbon atoms and n is from 2 to 5.

11. The high-viscosity, low-solids fabric softener formulation of claim 1 wherein said amine ethoxylated is present in an amount of from about 0.1 to about 1.5% by weight.

12. The high-viscosity, low-solids fabric softener formulation of claim 11 wherein said amine ethoxylated is present in an amount of from about 0.5 to about 1.0% by weight.

13. The high-viscosity, low-solids fabric softener formulation of claim 1 wherein said amine ethoxylate is VARONIC T202.

14. The high-viscosity, low-solids fabric softener formulation of claim 1 further comprising a detergent.

15. The high-viscosity, low-solids fabric softener formulation of claim 14 wherein said detergent includes at least one surfactant selected from the group consisting of anionic surfactants, non-ionic surfactants, amphoteric surfactants, zwiterionic surfactants and any combinations. or mixtures thereof.

16. A method comprising the steps of:
(a) providing a low-solids fabric softener composition which comprises from about 1 to about 10% of at least one dialkyl quaternary ammonium compound dispersed in water; and
(b) adding at least one amine ethoxylate having the formula(R(nEO))ₛNHₜ, wherein R is a saturated or unsaturated, linear or branched alkyl containing from 10 to 22 carbon atoms; EO is ethoxylate; n is the number of moles of EO and is from 1 to 10; s=1, 2 or 3; t=0, 1 or 2; and s+t=3, to said low-solids fabric softener composition, wherein said amine ethoxylate enhances the viscosity and softening of said low-solids fabric softener composition.

17. The method of claim 16 wherein said at least one dialkyl quaternary ammonium compound is a dialkyl ester quat, a dialkyl amido amine quat, a dialkyl imidazoline quat or combinations and mixtures thereof.

18. The method of claim 17 wherein said dialkyl quaternary ammonium compound is a dialkyl ester quat having the formula: 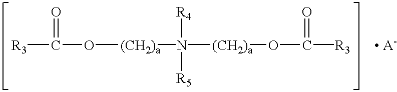
wherein each R₃ is the same or different and is a saturated C₉₋₂₃ alkyl; R₄ and R₅ are the same or different and are C₁₋₆ hydrocarbyl croup or hydroxy alkyl; a is from 1 to 6; and A is an anion selected from the group consisting of chloride, bromide, methyl sulfate, ethylsulfate, formate, acetate, carbonate, sulfate, and nitrate.

19. The method of claim 18 wherein said dialkyl ester quat is REWOQUAT WE-HV or VARISOFT WE-16.

20. The method of claim 17 wherein said dialkyl quaternary ammonium compound is a dialkyl amido amine quat having the following formula: 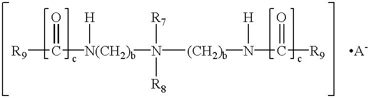
wherein R₇ and R₈ are the same or different and are C₁₋₄ alkyls, ethoxy or propoxy; each R₉ is the same or different and is a saturated C₇₋₂₇ alkyl; c is 0 or 1; b is 1 to 6; and A is an anion selected from the group. consisting of chloride, bromide, methyl sulfate, ethylsulfate, formate, acetate, carbonate, sulfate, and nitrate.

21. The method of claim 20 wherein said dialkyl amido amine quat is VARISOFT 110-75%.

22. The method of claim 17 wherein said dialkyl ammonium quaternary ammonium compound is a dialkyl imidazoline quat having the following formula: 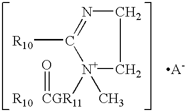
wherein R₁₀ is a saturated C₁₁₋₂₁ acyclic alkyl or alkylene C₁₁₋₂₁; R₁₁ is a divalent C₁₋₆ alkyl group; G is O or NH; and A is an anion selected from the group consisting of chloride, bromide, methyl sulfate, ethylsulfate, formate, acetate, carbonate, sulfate, and nitrate.

23. The method of claim 22 wherein said dialkyl imidazoline quat is: REWOQUAT W75H.

24. The method of claim 16 wherein said low-solids fabric softener composition includes from about 1 to about 10% of said at least one dialkyl quaternary ammonium compound dispersed in water.

25. The method of claim 16 wherein said amine ethoxylate contains from about 12-18 carbon atoms and n is from 2 to 5.

26. The method of claim 16 wherein said amine ethoxylated is added in an amount of from about 0.1 to about 1.5% by weight.

27. The method of claim 26 wherein said amine ethoxylated is added in an amount of from about 0.5 to about 1.0% by weight.

28. The method of claim 16 wherein said amine ethoxylate is VARONIC T202.
